(19) United States
(12) Patent Application Publication
(10) Pub. No.: US 2009/0152986 A1
(43) Pub. Date: Jun. 18, 2009

(54) PIEZOELECTRIC POWER SUPPLY

(76) Inventors: Ilan Beery, Nesher (IL); David Segal, Kiriat Tivon (IL)

Correspondence Address: YORAM TSIVION, P.O. BOX 1307, PARDES HANNA, 37111, IL

(21) Appl. No.: 11/719,565

(22) PCT Filed: Nov. 16, 2005
(86) PCT No.: PCT/IL05/01212

§ 371 Date: May 17, 2007

(30) Foreign Application Priority Data
Nov. 17, 2004 (IL) 165270

(51) Int. Cl. H02N 2/18

(52) U.S. Cl. 310/319

(57) ABSTRACT

An energy generating and storing circuit suitable for use on board a projectile. The circuit includes a current generator consisting of one or more piezoelectric devices, a primary charge storage device and one or more secondary charge storage devices, a voltage responsive fast switching means and at least one transformer. The circuit provides for loading the primary charge storage before the secondary charge storages are loaded. The circuit provides for storing electric energy generated during the compression and decompression phases of the piezoelectric devices during the firing stage of the projectile.

### FIELD OF THE INVENTION

The present invention relates generally to piezoelectric power supplies and more specifically to energy transfer and electric charge storage within piezoelectric power supplies. The invention also relates to firing fuzes of projectiles and to safety thereof.

### BACKGROUND OF THE INVENTION

Piezoelectric power supplies are commonly used to power firing fuzes on board projectiles. A portion of kinetic energy of the projectile is converted to electrical energy stored in suitable capacitors by deforming piezoelectric devices during the acceleration increase or decrease stages. Pressed piezoelectric devices are equivalent to charged electric capacitors. Applying pressure across a piezoelectric device results in deformation associated with charging opposing compressed faces with electric charges of opposing signs. With the decrease in pressure decompression takes place, in which the voltage between its faces decreases.

U.S. Pat. No. 3,670,653 discloses a method and system in which a considerable amount of the electrical energy generated by the piezoelectric device is stored in a storage capacitor. Energy is transferred by means of a suitable transformer coupling the piezoelectric device with the storage capacitor. This energy is further used to activate a wire bridge detonator. Activation at a predetermined voltage threshold is achieved by means of a voltage responsive fast switching means implemented by a Shockley avalanche diode.

U.S. Pat. No. 3,624,451 discloses a biasing network and transistorized switching means employed for detonator activation.

Both above mentioned inventions are suitable for firing fuzes, which are loaded and immediately activated during the projectile impact. Loading a power source during the firing stage of a projectile associated with controlled fuze activation requires further safety and control measures.

### BRIEF DESCRIPTION OF DRAWING

FIG. 1 is a schematic drawing depicting a preferred embodiment of an energy generating and storage circuit (EGSC) according to the present invention;

FIG. 2 is a schematic drawing depicting another preferred embodiment of an EGSC according to the present invention;

FIG. 3 is a plot of typical voltage-time profiles obtained by using an EGSC of the invention;

FIG. 4 is a plot of typical voltage-time profiles obtained by using an EGSC of the invention.

### DETAILED DESCRIPTION OF THE INVENTION

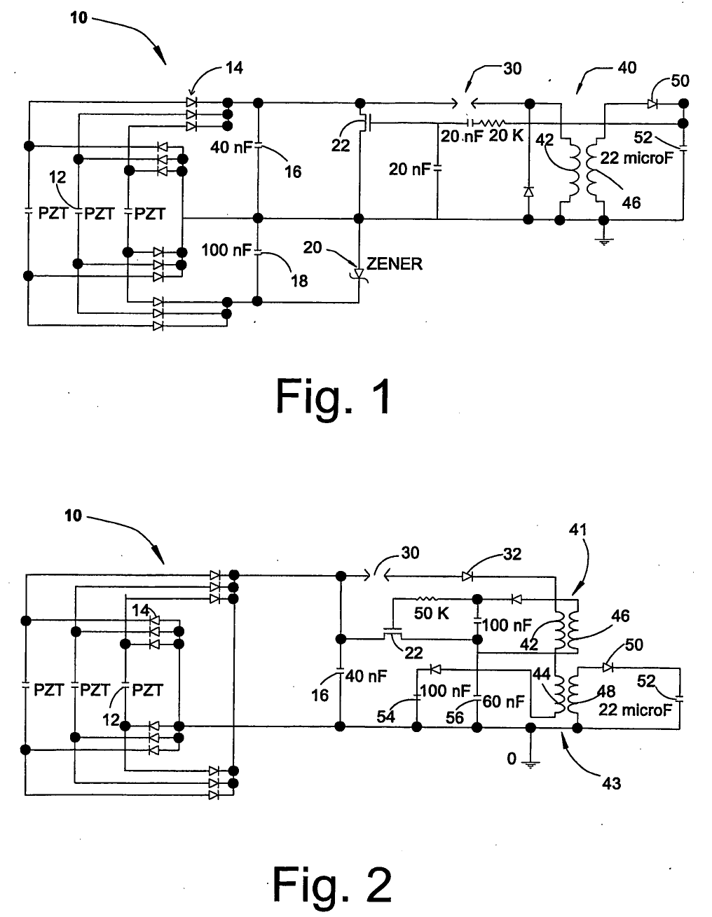

In FIG. 1 to which reference is made, a schematic drawing of a preferred embodiment of an energy generating and storage circuit (EGSC) according to the present invention is shown. Current generator 10 employing a plurality of piezoelectric devices 12 coupled in parallel consisting of ferroelectric ceramic disks such as lead zirconate titanate (PZT). Current generator 10 provides current having a predetermined polarity by means of unidirectional current limiting devices 14 configured into diode bridge. Two electric charge storage means are coupled in parallel to the current generator 10. Intermediate electric charge storage means 16 consisting of a suitable capacitor, is electrically charged during the compression of the piezoelectric devices. Secondary electric charge storage means 18 consisting of a suitable capacitor, is electrically charged during the decompression phase of same piezoelectric devices. Voltage protection device 20 consisting of Zener diode is connected in parallel to the secondary electric charge storage means. Transformer 40 with a primary coil 42 serially connected to a voltage responsive fast switching means 30, is coupled to the intermediate electric charge storage means 16. A suitable spark gap activated at a voltage exceeding voltage threshold across intermediate charge storage means, serves as a voltage responsive fast switching means. The transformer secondary coil 46 is parallel connected to a series combination of a unidirectional current limiting device 50 and a primary electric charge storage means 52 consisting of a suitable capacitor.

A transformer with a storage capacitance coupled to its secondary coil is commonly used for an efficient energy transfer at specified voltages. Voltage responsive fast switching means 30, configured to switch on at a voltage across the intermediate electric charge storage means 16 exceeding a voltage threshold, is employed according to the present invention. Energy stored in charge storage means 16, is converted to magnetic energy built up in the transformer primary coil 42 immediately following the switching on of the voltage responsive fast switching means. Electric current further generated in transformer secondary coil 46 loads primary electric charge storage means 52. When the voltage across primary electric charge storage means 52 exceeds a predetermined voltage threshold, transistorized electronic switching means 22 is switched on and shortcuts intermediate electric charge storage means 16 to the ground.

Such switching prevents any residual charge in intermediate electric charge storage means 16 from interfering with the electric charge of opposite polarity generated during the decompression phase. A portion of this electric charge generated during decompression phase is stored in secondary electric charge storage means 18. Voltage protection device 20 guarantees a suitable amount of energy to be loaded. Energy stored in secondary electric charge storage means 18 is used thereafter to activate actuators, firing fuzes, or the like, controlled by logic circuitry, which is powered by primary electric charge storage means 52. The logic circuitry and the actuators are not shown.

Such voltage responsive fast switching means has response time in the sub-microsecond range, significantly short compared to typical time scale of the RLC circuit or the time scale of the mechanical stresses applied. Incorporating such fast switching means in the transformer primary circuit results in a significant reduction in the cross section area of the transformer core employed. Incorporating further such transistorized electronic switching means induces substantially sequential charging process. First the primary electric charge storage means is fully loaded during the compression phase. Loading the secondary electric charge storage means is induced provided that the primary electric charge storage means is fully loaded and starts only a while afterwards at the beginning of decompression phase.

Improved loading efficiency of both primary and secondary electric charge storage means is gained in accordance with the present invention, due to the fast switching means 30 and transistorized electronic switching means 22 incorporated.

The number and features of piezoelectric devices employed limit the number and is capacitances of primary and secondary electric charge storage means. Embodiments consisting of a plurality of secondary electric charge storage means or primary electric charge storage means are also possible in accordance with the present invention.

Direct coupling of capacitors is less efficient than coupling by means of suitable transformers, in terms of energy transfer. This inefficiency is significant when dealing with storage means of low voltage and high capacitance as the primary electric charge storage means. Therefore the primary electric charge storage means is coupled to the current generator by means of transformer. The secondary electric charge storage means has considerably lower capacitance, of the same order of magnitude as the capacitance of the intermediate output electric charge storage means. Therefore it is directly coupled to the current generator. Embodiment variants in which the secondary electric charge storage means are also coupled to the current generators by means of transformers, or employing transformers consisting of one primary coil and multiple secondary coils are possible according to the present invention.

Reference is now made to FIG. 2, showing another preferred embodiment of an EGSC according to the present invention. Current generator 10 providing current in a predetermined polarity is coupled to intermediate electric charge storage means 16. Intermediate electric charge storage means 16, is coupled in parallel to a series combination of voltage responsive fast switching means 30 connected by a unidirectional current limiting device 32 to primary coil 42 of transformer 41, which is serially connected to primary coil 44 of transformer 43, which is further serially connected to additional charge storage means 56. A unidirectional current limiting device 58 serially connected with secondary electric charge storage means 54 are connected in parallel to the additional charge storage means 56. Secondary coil 48 of transformer 43 is connected in parallel to a serial combination of a unidirectional current limiting device 50 and primary electric charge storage means 52. Transistorized electronic switching means 22, forward biased by a delay network coupled to the secondary coil 46 of transformer 41, connects in parallel intermediate electric charge storage means 16 with the additional electric charge storage means 56, when turned on after a predetermined delay after voltage across primary charge storage means exceeds voltage threshold.

EGCS in such configuration consists of one primary electric charge storage means 52 and two secondary electric charge storage means. One of these secondary electric charge storage means consists of intermediate electric charge storage means 16 connected in parallel to the additional electric charge storage means 56.

The number of the piezoelectric devices, the inductance and capacitance values all fit in with the capacitance of the piezoelectric devices employed and energy and voltage requirements related to the logic circuitry and actuators to be powered.

The present invention provides inherent safety mechanism, in which secondary electric charge storage means are loaded only after loading of the primary electric charge storage means is accomplished. The present invention may also provide additional operational capabilities, such as changeable timing of fuze firing, incorporating an additional sensor in a projectile and conditioned fuze firing by the output values of this additional sensor or an independent sensor.

The method and system of the present invention may be better understood by reference to the examples and drawings detailed below.

### EXAMPLE 1

An EGSC as in FIG. 1, consists of resistors and capacitors as shown. Spark gap of CP Clair type CG2-1000L is employed as the voltage responsive fast switching means. The transformer employed is an ACP 210-18.4-12.7-04.8-GP type, having an effective core cross-section of 11 mm². Measured capacitance of the coupled three piezoelectric devices employed is 7.5 nF.

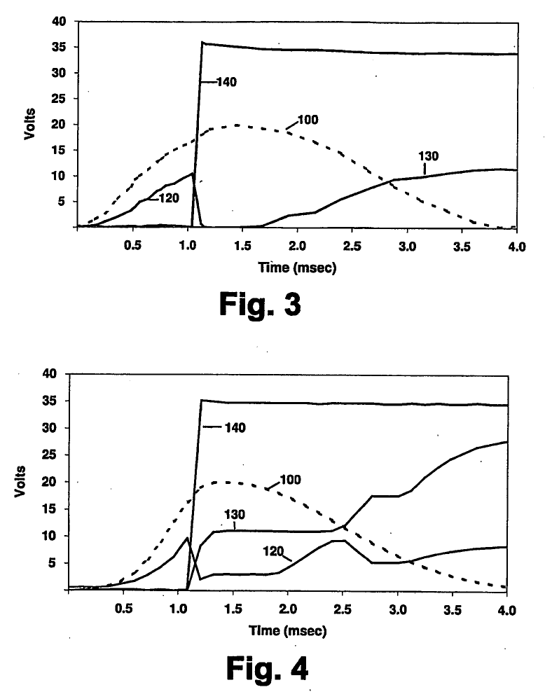

Reference is now made to FIG. 3, in which measurements performed on this EGSC are shown. Theoretical values of the pressure applied across the piezoelectric devices are illustrated by curve 100. The pressure increases reaching its maximal value at t=1.44 milliseconds and then decreases monotonically at different rates from that moment on. Curve 120, represents the voltage measured in volts across the 40 nF capacitor, which is the intermediate output electric charge storage means, divided by 100. Curve 130 represents the voltage measured across the secondary electric charge storage means Implemented by a 100 nF capacitor, divided by 30. Curve 140 represents the voltage as measured over the primary electric charge storage means implemented by a 22 μF capacitor. Increasing pressure induces charging of the 40 nF capacitor. Mechanical vibrations may cause deviations from a monotonic rise. When this voltage exceeds 1000 volts, at t=1.08 milliseconds, the spark gap switches on instantaneously. The primary electric charge storage means is is charged very rapidly reaching its maximal voltage value within 5 microseconds. Thereafter the transistorized electronic switching means 22 is switched on draining to ground charge residue and charge further generated from that moment up to the end of compression phase. Loading the secondary electric charge storage means practically starts at t=1.44 milliseconds.

An EGSC in accordance with the present invention, incorporated into a firing fuze of a projectile promotes its safety. The voltage level for firing is reached only after sufficient resources for powering the control logic circuitry are assured.

### EXAMPLE 2

An EGCS as in FIG. 2 was used for measurements of time-voltage profiles. Reference is made to FIG. 4, in which typical time-voltage profiles measured employing this EGCS, are plotted. Theoretical values of the pressure applied across the piezoelectric devices are illustrated by curve 100. Time dependent voltage values measured over the intermediate electric charge storage means 16 and divided by 100, are represented by curve 120. Time dependent voltage values measured over the secondary electric charge storage means 54 and divided by 30, are represented by curve 130. Time dependent voltage values as measured over the primary electric charge storage means 52 are represented by curve 140. Increasing pressure across the piezoelectric devices causes the intermediate electric charge storage means to be charged. At t=1.08 milliseconds the voltage over the intermediate electric charge storage means exceeds 970 volts, the voltage responsive fast switching means turns on and charging the primary electric charge storage means is started. At a predetermined time, at t=2.5 milliseconds significantly after the voltage across the primary electric charge storage means has reached its maximal value, the transistorized switching means 22 turns on. Intermediate electric charge storage means 16, secondary electric charge storage means 54 and the additional electric charge storage means 56 are coupled in parallel as of this instance. Voltages over these electric charge storage means start to build up during the compression phase and continue building during the decompression phase. New charge generated by decompressing the piezoelectric devices is accumulated with charge residues from the compression phase. Voltage reaches its target value, which is the actuator, or fuse operation level, significantly after loading of the primary electric charge storage means is accomplished.

1. An energy generating and storing circuit (EGSC) comprising:
at least one current generator consisting of at least one piezoelectric device providing a current of a predetermined polarity;
an intermediate electric charge storage means coupled to said current generator;
at least one primary electric charge storage means loaded by energy stored in said intermediate electric charge storage means;
at least one secondary electric charge storage means coupled to said current generator;
at least one transistorized electronic switching means forward biased into conductivity at a voltage exceeding a predetermined threshold value, connected to the positive terminal of said intermediate electric charge storage means, wherein the other terminal of said intermediate electric charge storage means is grounded;
a circuit for energy transfer further comprising:
at least one transformer coupled to said intermediate electric charge storage means having a primary coil and at least one secondary coil;
a voltage responsive fast switching means serially connecting said positive terminal of said intermediate electric charge storage means to one terminal of said transformer primary coil;
a secondary circuit consisting of a unidirectional current limiting device serially connected to said primary electric charge storage means connecting both terminals of said transformer secondary coil.

2. An EGSC as in claim 1, wherein said EGSC is installed on board a projectile.

3. An EGSC as in claim 1, wherein said transistorized electronic switching means connects said positive terminal of said intermediate charge storage means to the ground.

4. An EGSC as in claim 1, further comprising:
at least one additional electric charge storage means serially connecting the other terminal of said transformer primary coil to the ground;
at least one serial combination of a unidirectional current limiting device and one of said secondary electric charge storage means connected in parallel to said additional charge storage means;
a unidirectional current limiting device serially connecting said voltage responsive fast switching means with said terminal of said transformer primary coil, and
wherein said transistorized electronic switching means connects in parallel said additional electric charge storage means with said intermediate output electric charge storage means.

5. A method for loading at least one primary electric charge storage means and at least one secondary electric charge storage means, comprising:
charging an intermediate output electric charge storage means, by forcing current generator consisting of at least one piezoelectric device, wherein said charging is induced at least during the compression of said piezoelectric devices;
loading said primary electric charge storage means by electrically connecting said intermediate electric charge storage means to a primary coil of transformer, wherein said connection is induced above a voltage threshold across said intermediate electric charge storage means during the compression of said piezoelectric devices, and whereas at least one secondary coil of said transformer is coupled to at least one of said primary electric charge storage means;
loading said secondary electric charge storage means at least during the decompression of said piezoelectric devices.

6. A method for loading at least one primary electric charge storage means, and at least one secondary electric charge storage means as in claim 5, said method further including grounding said intermediate electric charge storage means above voltage threshold across said primary electric charge storage means.

7. A method for loading at least one primary electric charge storage means and at least one secondary electric charge storage means as in claim 5, said method further including electrically connecting said intermediate electric charge storage means in parallel with at least one series combination of a unidirectional current limiting device and one of said secondary electric charge storage means, wherein said electrical connection induced after a predetermined delay following the time that voltage threshold is achieved across said primary electric charge storage means.
